(19) United States
(12) Patent Application Publication
(10) Pub. No.: US 2008/0102743 A1
(43) Pub. Date: May 1, 2008

(54) HOOD MOUNTED DISPLAY SYSTEM

(75) Inventor: Steve Williams, Reno, NV (US)

Correspondence Address: IAN F. BURNS & ASSOCIATES, P.O. BOX 71115, RENO, NV, 89570, US

(73) Assignee: INDEPENDENT, INC., Sparks, NV (US)

(21) Appl. No.: 11/306,144

(22) Filed: Dec. 16, 2005

Related U.S. Application Data
(60) Provisional application No. 60/674,773, filed on Apr. 25, 2005.

(51) Int. Cl. F24C 15/20; H04N 9/12

(52) U.S. Cl. 454/56; 348/739

(57) ABSTRACT

The present invention comprises a hood for mounting above an area where air is desired to be exhausted. The hood includes a frame having a front wall and a cavity. A filter may be mounted to the frame in the cavity. A video display is mounted to the front wall. The video display can show a video presentation.

### CROSS REFERENCE TO RELATED APPLICATIONS

This application claims priority to U.S. provisional patent application Ser. No. 60/674,773, filed Apr. 25, 2005 and entitled, “Hood Mounted Display System,” the contents of which are herein incorporated by reference.

### BACKGROUND

1. Field of the Invention

The present invention relates to a hood that is used to remove air over a range or other cooking device. In particular, the invention relates to a hood that incorporates a video display.

2. Description of the Related Art

Hoods are typically used in kitchens and cooking areas to collect and remove air from the cooking areas that contain heat, smoke, odors and airborne grease particles. Hoods are often mounted over cooking appliances, such as ranges or grilles. A fan in the hood is generally used to draw contaminated air into the hood. The air can be vented out of the building, or the air can be partially or wholly filtered and recirculated back into the building.

Kitchen hoods are typically mounted in a central location in the kitchen. Hoods can be mounted below or between an upper row of kitchen cabinets. Hoods are generally very visible from other locations in the kitchen. Since hoods are very visible, it is desirable that in residential uses they be as aesthetically attractive and visually appealing to users and visitors to the kitchen area as possible. Space is typically limited in a kitchen area. With the large number of kitchen appliances available for purchase, the typical kitchen can readily become crowded. Therefore, it is desirable that any new kitchen appliance be able to combine several kitchen functions and have a compact package in order to save kitchen space.

Televisions and video displays are frequently placed in kitchen areas. Since, a large percentage of a homeowners time is spent in the kitchen, having a television in the kitchen is advantageous. The use of televisions in kitchens is increasing in popularity. A television allows the kitchen user to be entertained and to keep up to date on the latest news, sports and weather. Unfortunately, there is often little space for a television in a kitchen area. Televisions and video displays that are placed on counter tops are often in the way and take up valuable kitchen counter space. Televisions and video displays require signal cables and electrical power cables that can be difficult to route around appliances and cabinets.

Examples of cooking appliances combined with a television are shown in Vargas (U.S. Pat. No. 6,809,295), Guenther (U.S. patent publication 2003/0098888), Mahloch (U.S. patent publication 2004/0051645), Ohyama (U.S. Pat. No. D273,836) and Heo (U.S. Pat. No. 4,628,351).

While these devices show an appliance with a television, none of them disclose an apparatus for removing and exhausting air from a cooking area.

### SUMMARY

### ADVANTAGES OF ONE OR MORE EMBODIMENTS OF THE PRESENT INVENTION

The various embodiments of the present invention may, but do not necessarily, achieve one or more of the following advantages: display a video presentation in a cooking area; provide an air removal device for a kitchen; provide an aesthetically appealing kitchen appliance; provide a kitchen hood that includes a video display; provide a light for illuminating a cooking area; provide a kitchen hood that combines several functions; and withdrawing air from a cooking area and filtering the air. These and other advantages may be realized by reference to the remaining portions of the specification, claims, and abstract.

### BRIEF DESCRIPTION

The present invention comprises a hood that includes a frame having a front wall and a cavity. A filter is mounted to the frame in the cavity. A video display is mounted to the front wall.

The present invention further comprises a method of removing air from a cooking area that includes moving air from the cooking area through a filter and to an exhaust port. A video presentation is shown on a video display. The video display is coupled with the filter and is visible from the cooking area.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The embodiments of the present invention are shown in the drawings, wherein:

FIG. 1 is substantially a front perspective view of an embodiment of a hood mounted display system in accordance with the present invention.

FIG. 2 is substantially a side cross-sectional view of FIG. 1 taken along section line A-A of FIG. 3.

FIG. 3 is substantially a bottom view of FIG. 1.

FIG. 4 is substantially a rear view of FIG. 1.

FIG. 5 is substantially a partial enlarged view of FIG. 2 showing details of the display mounting.

### DESCRIPTION OF THE EMBODIMENTS

In the following detailed description of the embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

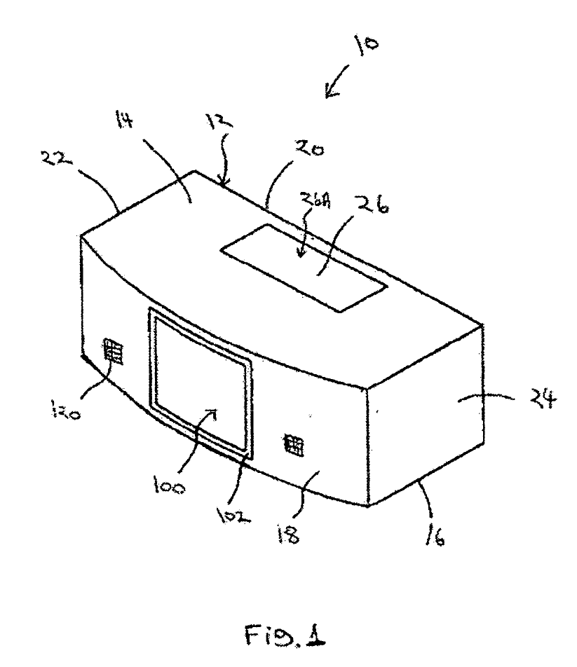

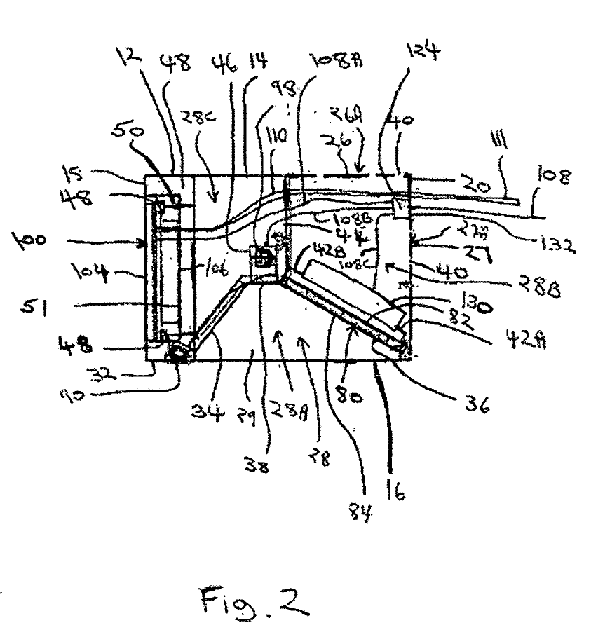

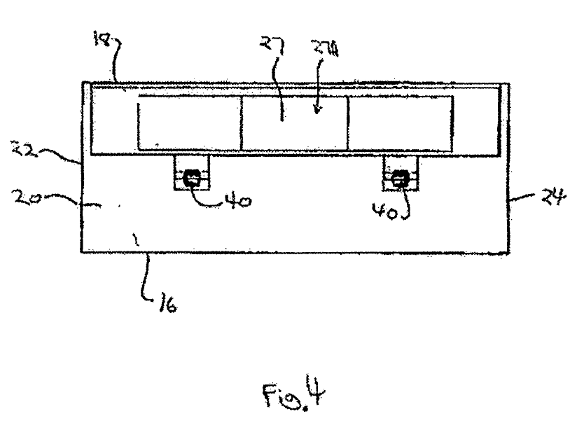

The present invention comprises a hood assembly, generally indicated by reference number 10. Referring to FIGS. 1 and 2, hood assembly 10 includes a frame or enclosure 12 and a video display 100 mounted in the frame. Frame 12 is substantially rectangular in shape. Frame 12 has top wall 14, bottom wall 16, curved front wall 18, back wall 20, side wall 22, and side wall 24. Walls 14, 16, 18, 20, 22, and 24 can enclose and define a cavity 28. Frame 12 may be made of welded steel sheets. Frame 12 may of course be made of other materials known in the art, such as molded plastic or other metals. An opening 29 is located in bottom wall 16. Exhaust opening knockouts 26 can be located in top wall 14. Referring to FIGS. 2 and 4, exhaust opening knockouts 27 are located in back wall 20. The exhaust opening knockouts provide a location for the hood to be connected to the external duct work, so that air may be exhausted to the outside of a building. The exhaust opening knockouts would be removed at the time of installation to provide an exhaust opening or port 26A or 27A.

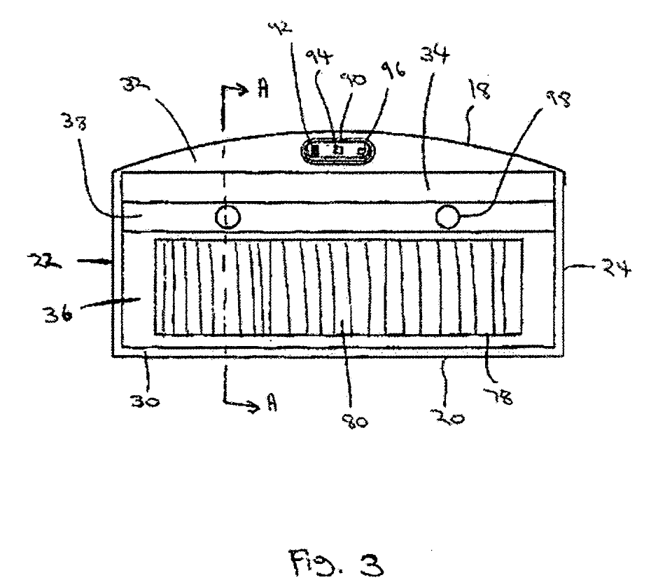

Turning now to FIGS. 2 and 3, bottom wall 16 can have a lip 30, a surface 32, and a flat surface 38. Mounting holes 40 are located in top wall 14 and back wall 20. The mounting holes are used to attach hood assembly 10 to a wall or other support structure in a building. A support bracket 44 is mounted to top wall 14 and extends downwardly into cavity 28.

Flat surface 38 may be attached to support bracket 44. Angled surface 34 can be attached between flat surface 38 and surface 32. Angled surface 36 is attached between flat surface 38 and back wall 20. Filter brackets 42A and 42B can be attached to angled surface 36. An opening 78 is located in angled surface 36. Support bracket 44, angled surface 34 and angled surface 36 divide cavity 28 into cavity portions 28A, 28B and 28C.

A light box 46 can be mounted to support bracket 44 in cavity portion 28C. Light box 46 can contain a light 98. Light 98 is adapted to illuminate the cooking area below hood assembly 10. A power cable 108B is connected with light 98 in order to supply electrical power to light 98.

A filter 80 can be mounted to filter brackets 42A and 42B in opening 78. Filter 80 can be a metal filter with baffles that traps and removes airborne grease particles or can be a filter with a media such as activated charcoal. Filter 80 has a top side 82 and a bottom side 84 that faces opening 29. Fan 130 is also mounted to filter brackets 42A and 42B in cavity 28B. Fan 130 can be any suitable type of fan. Fan 130 pulls air through filter 80 and pushes air out through one of exhaust ports 26A or 27A. A power cable 108C is connected to fan 130.

It is noted that while fan 130 is shown mounted to frame 12, fan 130 can also be omitted. Fan 130 is omitted when hood assembly 10 is connected with a ductwork or exhaust that has an applied vacuum or exhaust. In other words, the fan would be connected with the ductwork farther toward the exhaust outlet. For example, a fan could be mounted on the roof of a building and connected to hood assembly 10 through ducts.

A control panel 90 can be mounted to surface 32. Control panel 90 can have a switch 92, button 94 and button 96. Switch 92 is connected with fan 130 and can turn fan 130 on and off. Button 94 is connected with light 98 and can turn light 98 on and off. Button 96 is connected with video display 100 and can turn video display 100 on and off.

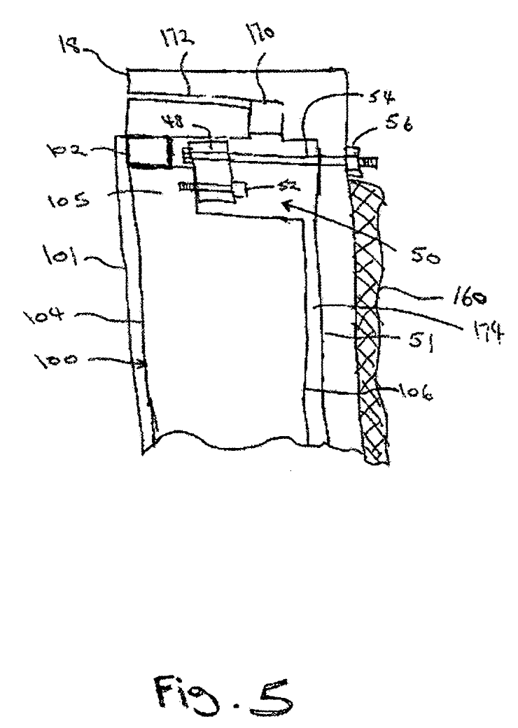

Referring to FIGS. 2 and 5, a recess 50 can be formed in front wall 18. Recess 50 has a rear wall 51. A display bracket 48 is mounted to display 100 using a fastener 52. Fastener 52 can be a screw that is attached to a threaded portion 105. Display bracket 48 is attached to rear wall 51 using a fastener 54. Fastener 54 can be retained by a nut 56. Frame 102 can be press fit around display 100 as a decorative molding to hide display bracket 48 and fastener 54.

Video display 100 has a frame 102, front 104 and back 106. Video display 100 may be mounted in recess 50. Video display 100 can be any suitable display that is capable of showing video presentations, such as liquid crystal displays, plasma displays, cathode ray tubes, electroluminescent displays or projection displays. Video display 100 can be mounted such that video display front 104 is flush with front wall 18. A protective cover 101 (FIG. 5) can be mounted over video display 100. Cover 101 can be made from clear acrylic and protect display 100 from grease and abrasion. Cover 101 can be mounted with frame 102. Cover 101 may be readily removed for cleaning. Insulation 160 can be placed on rear wall 51 in order to insulate video display 100 from any hot gases being exhausted in cavity 28.

Alternatively, a fan 170 can be mounted adjacent recess 50 in order to cool video display 100. Fan 170 can intake cool air through an intake port 172 and pass the cool air through gap 174 behind video display 100 in order to cool the video display.

A power cable 108A and coaxial video cable 110 are connected with video display 100. Coaxial video cable 110 has an end 111 that extends from back wall 20 and is adapted to be connected to another coaxial connector or cable. Power cable 108 is adapted to be connected with a source of electrical power. Power cables 108A, 108B and 108C can be connected to a junction box 124. Junction box 124 can be mounted to back wall 20. The three power cables 108A, 108B and 108C may be connected together in box 124 and are further connected to power cable 134. Power cable 108 can extend from back wall 20 so that the cable can be connected to an external power outlet.

Speakers 120 (FIG. 1) can be mounted in front wall 18. Speakers 120 are connected with video display 100 and provide sound and audio in conjunction with a video presentation. Alternatively, speakers 120 can be used without video display 100 to play music or radio. Video display 100 can show a wide variety of video presentations that are entertaining and informative, such as movies or news. Video display 100 can also display information. For example, if hood assembly 10 is mounted in a restaurant, video display 100 could display customer orders or cooking information such as temperature and time to restaurant personnel. The hood can serve as a location to present data, information or entertainment because of its highly visible location.

Video cable 110 (FIG. 2) is adapted to be connected with a video source or signal such as television, a video tuner, DVD player, video cassette recorder, computer server, computer system, satellite tuner or cable television cable.

Alternatively, hood assembly 10 may include a media player or receiver device mounted within frame 12. For example, a DVD player, compact disc player, television tuner, tape player could be mounted in frame 12 and be in communication with video display 100. Hood assembly 10 can also include other types of communication devices such as radios or closed circuit televisions.

A remote control device (not shown) may be in wireless communication with video display 100 for controlling the video display. Video display 100 may also receive information through wireless means such as through a wireless network or a television transmitter. Other computers may be located in the kitchen area and be in communication with video display 100. Video display 100 can use wireless communications to obtain information and transmit data between other input devices and sources of information.

It can be realized that certain embodiments of the present invention provide a hood and display device that can both exhaust air from a cooking area and display an entertaining video presentation. It can further be realized that the combination of a hood and video display results in a compact package that can save kitchen space. The present invention also provides a hood and video display that can filter contaminated air and show a video presentation.

It is noted that hood assembly 10 is not limited for use in a kitchen. Hood assembly 10 may be used in any location where air is needed to be exhausted such as bathrooms, basements, restaurants, garages, commercial buildings and airports.

### CONCLUSION

It can thus be realized that the certain embodiments of the present invention can provide a hood for exhausting air that can also present video presentations in a highly visible location. Certain embodiments combine a kitchen hood and a video display in a compact package that requires less space.

Although the description above contains many specifications, these should not be construed as limiting the scope of the invention but as providing illustrations of some of present embodiments of this invention. Thus, the scope of the invention should be determined by the appended claims and their legal equivalents rather than by the examples given.

What is claimed is:

1. A hood for exhausting air comprising:
a frame having a front wall and side walls defining a cavity, the cavity being adapted to allow airflow; and
a video display mounted to the front wall, the wall separating the cavity from the video display.

2. The hood of claim 1, further comprising a recess located in the front wall, the video display being mounted in the recess.

3. The hood of claim 1, wherein a fastener retains the video display to the frame.

4. The hood of claim 1, wherein a fan is mounted to the frame for cooling the video display.

5. The hood of claim 1, wherein an insulation is mounted to the frame for insulating the video display.

6. The hood of claim 1, wherein a cover is mounted over the video display to protect the video display.

7. The hood of claim 1, wherein a filter is mounted to the frame for filtering air.

8. The hood of claim 1, wherein a fan is mounted to the frame for drawing air through the filter.

9. A hood for removing air comprising:
a frame having a front wall, and side walls defining a cavity, the frame further having a bottom opening;
a bracket mounted to the frame and located in the cavity, the bracket being adapted to hold at least one filter; and
a video display mounted to the front wall.

10. The hood of claim 9, wherein a bracket and fastener retains the video display to the front wall.

11. The hood of claim 9, wherein a coaxial cable is connected to the video display.

12. The hood of claim 11, wherein the front wall has a recess, the video display being mounted in the recess.

13. The hood of claim 9, wherein a filter is mounted to the bracket and is adapted to filter air drawn through the opening.

14. The hood of claim 9, wherein a rear wall separates the video display from the cavity.

15. The hood of claim 9, wherein a fan is mounted to the frame in the cavity.

16. A hood assembly comprising:
frame means;
filter means mounted to the frame means for filtering an air stream; and
video display means mounted to the frame means for displaying a video presentation.

17. The hood assembly of claim 16, wherein the frame means further comprises:
a front wall;
a back wall;
a top wall;
a first and second side wall;
the walls defining a cavity; and
a bracket mounted to at least one of the walls and supporting the filter means.

18. The hood assembly of claim 16, further comprising fan means for moving air through the filter means.

19. A method of removing air from a cooking area comprising:
moving air from the cooking area to an exhaust port; and
displaying a video presentation on a video display, the video display being visible from the cooking area.

20. The method of claim 19, further comprising passing the air through a filter prior to moving to the exhaust port.
